(19) United States
(12) Patent Application Publication
(10) Pub. No.: US 2006/0068833 A1
(43) Pub. Date: Mar. 30, 2006

(54) Hand grips for hand held devices

(76) Inventor: Steven Paul Cohn, San Jose, CA (US)

Correspondence Address: Lorraine M. Donaldson, Esq., 281 Sea Forest Court, Del Mar, CA, 92014, US

(21) Appl. No.: 10/954,151

(22) Filed: Sep. 28, 2004

(51) Int. Cl. H04M 1/00

(52) U.S. Cl. 455/550.1; 455/575.1

(57) ABSTRACT

The present invention relates to a plurality of attachable handgrips for a cell phone. Preferably the handgrips can have an elongated generally flat and flexible base member having a sticky surface for attachment to a surface portion of the cell phone. The base member also has a grip surface for contact with the hand of the user of the cell phone. The grip surface has a plurality of wavy ridges or knobs extending upwardly from the grip surface. Preferably the base member is formed of a rubberized material.

### BACKGROUND OF THE INVENTION

1. Field of the Invention

The invention relates to grip products for hand held devices.

2. Description of Related Art

In using cell phones, a recurring problem is the dropping of the cell phones when a user tries to pick up or hold the cell phone. There are few individuals who have not dropped their cell phone multiple times. The damage resulting from dropping a cell phone is understood to be the number one cause for phone replacements, even beyond replacement for technical upgrades. Teens and adults alike appreciate the opportunity to personalize their equipment in a highly functional way.

A known attempt to help a user grip a cell phone involves a leather cell phone case. However, such covers are not desirable for most users who avoid them.

The present invention overcomes the aforementioned problem with dropping cell phones during use by providing stick on handgrips for cell phones and other hand-gripped appliances.

### BRIEF SUMMARY OF THE INVENTION

The present invention is directed to an attachable handgrip for a cell phone. The handgrip has an elongated generally flat and flexible base member having a sticky surface for attachment to a surface portion of the cell phone. The base member also has a grip surface for contact with the hand of the user of the cell phone. In alternative embodiments, the grip surface can have a plurality of wavy ridges or knobs extending upwardly from the grip surface. The base member is preferably formed of a rubberized material.

The present invention is also directed to an attachable handgrip for a hand-gripped appliance comprising a generally flat and flexible base member having a sticky surface for attachment to a surface portion of the appliance. The base member also has a grip surface for contact with the hand of the user of the appliance.

### BRIEF DESCRIPTION OF THE DRAWINGS

The present invention is described in detail below with reference to the drawings in which:

FIG. 1 is a perspective view of a cell phone held by a user with the fingers of one hand in contact with one or more handgrip in accordance with the present invention;

FIG. 2 is a back view of a cell phone with several handgrips in accordance with the present invention;

FIG. 3 illustrates a side view of a cell phone with a handgrip in accordance with the present invention; and

FIG. 4 is a perspective view of a cell phone held by a user with the fingers of one hand in contact with an alternative preferred embodiment of one or more handgrips in accordance with the present invention.

### DETAILED DESCRIPTION OF THE PREFERRED EMBODIMENTS

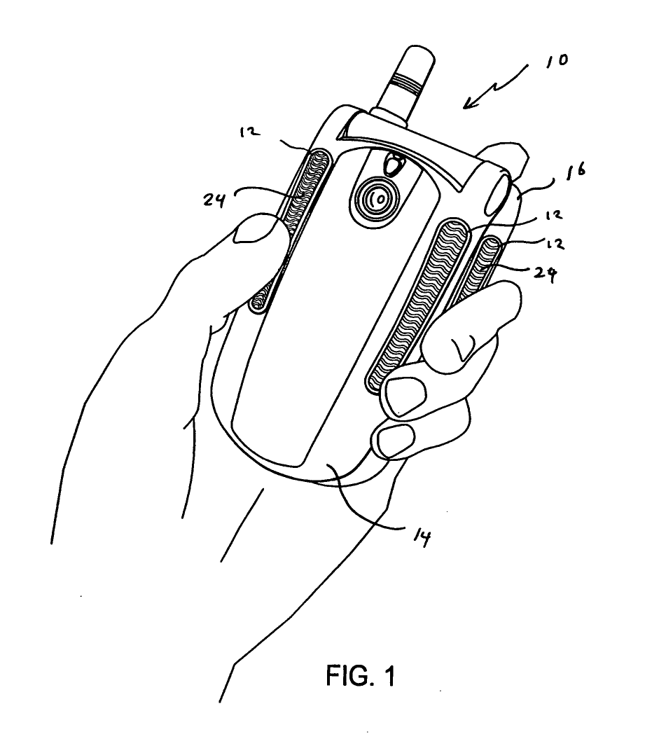

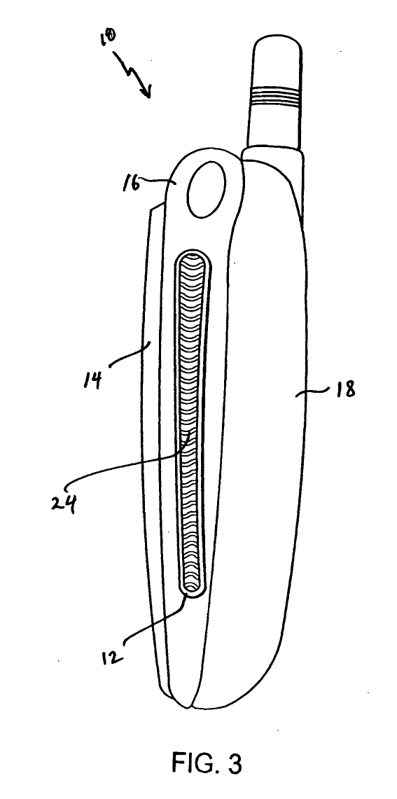

With reference to FIG. 1, a cell phone 10 is shown held in the left hand of a user. Handgrips 12 in accordance with the present invention are shown positioned on the cell phone 10. Preferably, two handgrips 12 are disposed near opposite edges on the cover 14 of the cell phone 10. Also one handgrip 12 is shown on one side 16 of the cell phone 10 which is also shown without the user's hand in FIG. 3.

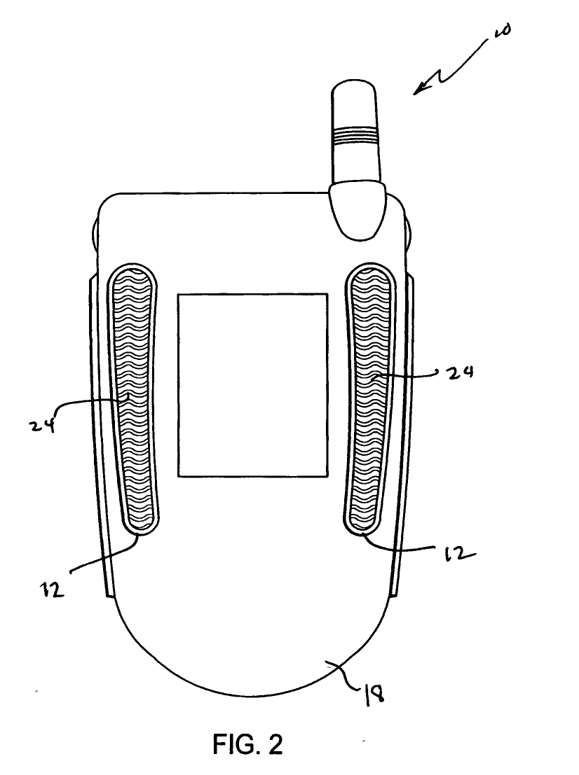

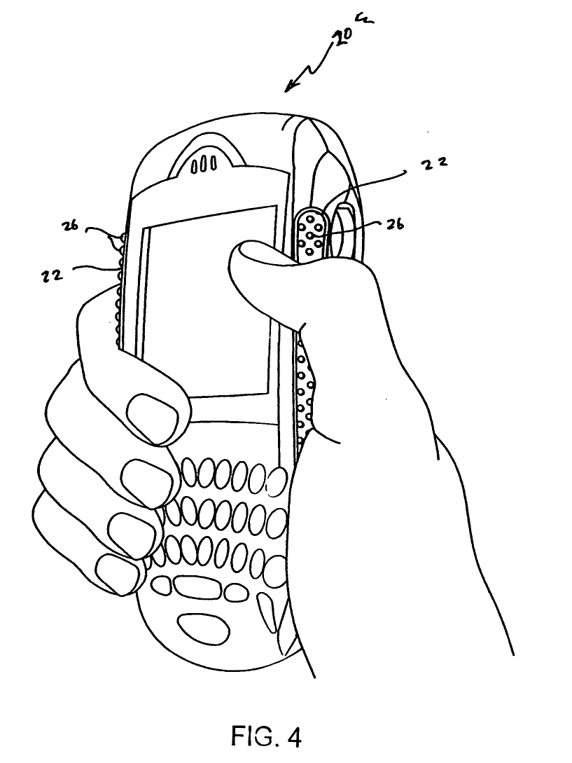

As shown in FIG. 2, the back 18 of cell phone 10 can have two handgrips 12 positioned along the edges of back 18. Another type of a cell phone 20 is shown in FIG. 4 with an alternative embodiment of handgrips 22 shown positioned along the sides of the cell phone 20.

The handgrips 12 are generally elongated and have a grip surface 24 such as wavy ribs or ridges standing up on the grip surface and a sticky back surface (not shown). In an alternative embodiment as shown in FIG. 4, the grip surface 24 can have circular knobs 26 extending upwardly as shown. The handgrips 12 can be assembled on a non stick surface sheet which can contain several handgrips 12. They can then be peeled-off and positioned where desired on an appliance such as a cell phone 10 or 20. The handgrips can have various design shapes to accommodate the hand contact surfaces of the appliances on which the handgrips are applied. In alternative embodiments, the handgrips 12 can have various shape designs running from high tech mat patterns to brightly colored surfboards, skateboards and support theme designs. The handgrips 12 can be made from rubberized, spongy grip, elevated material.

Teens and adults alike appreciate the opportunity to personalize their equipment in a highly functional way. As gifts, stix grips are good stocking stuffers and easily affordable.

Stix grips of handgrips can be adapted by shape to fit many appliances or things from steering wheels to “fat pen grips”, stationary phones, brushes, hair dryers, calculators and can be placed on virtually any hand-gripped appliance. Being decorative, they may be colored and shaped, and be placed on lockers, mirrors and used to stick pictures on refrigerators. Stick grips can run from an inch to two (2) inches in height and half an inch to an inch in width; thickness varies. Packaging should include a variety of choices (i.e., “high tech”, sport, day-glow, animals, and causes). In alternative preferred embodiments, movie characters or promotional information on the grips 12 is feasible.

While the instant invention has been shown and described herein in what are conceived to be the most practical and preferred embodiments, it is recognized that departures, modifications, adaptations, variations and alterations in the described methods and systems may be made and will be apparent to those skilled in the art of the foregoing description which does not depart from the spirit and scope of the invention which is therefore not to be limited to the details herein. For this reason, such changes are desired to be included within the scope of the appended claims. The descriptive manner which is employed for setting forth the embodiments should be interpreted as illustrative but not limitative of the full scope of the claims which embrace any and all equivalents thereto.

What is claimed is:

1. An attachable handgrip for a cell phone comprising an elongated generally flat and flexible base member having a sticky surface for attachment to a surface portion of the cell phone, the base member also having a grip surface for contact with the hand of the user of the cell phone.

2. The handgrip of claim 1 wherein the grip surface has a plurality of wavy ridges extending upwardly from the grip surface.

3. The handgrip of claim 1 wherein the grip surface has a plurality of knobs extending generally upwardly from the grip surface.

4. The handgrip of claim 1 wherein the base member is formed of a rubberized material.

5. An attachable handgrip for a hand-gripped appliance comprising a generally flat and flexible base member having a sticky surface for attachment to a surface portion of the appliance, the base member also having a grip surface for contact with the hand of the user of the appliance.
